(19) United States
(12) Patent Application Publication
(10) Pub. No.: US 2013/0155454 A1
(43) Pub. Date: Jun. 20, 2013

(54) IMAGE FORMING APPARATUS AND IMAGE FORMING METHOD

(71) Applicants: Takashi Saitoh, Tokyo-to (JP); Yutaka Tamada, Shizuoka-ken (JP); Masato Sekine, Tokyo-to (JP)

(72) Inventors: Takashi Saitoh, Tokyo-to (JP); Yutaka Tamada, Shizuoka-ken (JP); Masato Sekine, Tokyo-to (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/705,628

(22) Filed: Dec. 5, 2012

Related U.S. Application Data
(60) Provisional application No. 61/577,178, filed on Dec. 19, 2011.

(51) Int. Cl. G06F 3/12

(52) U.S. Cl. CPC G06F 3/1296
USPC 358/1.15

(57) ABSTRACT

An image forming apparatus comprises a display unit and an image forming unit. The display unit displays a list of print jobs. The image forming unit forms an image based on the print job registered last, if a first printing instruction is given without selecting a print job from the list of print jobs displayed on the display unit.

### CROSS-REFERENCE TO RELATED APPLICATIONS

This application is based upon and claims the benefit of priority from U.S. Provisional Application No. 61/577,178 filed on Dec. 19, 2011; the entire contents of which are incorporated herein by reference.

### FIELD

Embodiments described herein relate to an image forming apparatus and an image forming method.

### BACKGROUND

The printer driver of a PC sends a printing file to a server. The server registers the printing file sent from the printer driver and stores the print of the printing file until the storage period of the registered printing file expires. The server sends a list of printing files to an image forming apparatus based on a user request. The image forming apparatus receives the list of printing files from the server and displays the received list of printing files.

The user selects a desired printing file from the list of printing files displayed on the image forming apparatus. Correspondingly, the image forming apparatus requests the selected printing file from the server, and the server sends the requested printing file to the image forming apparatus. The image forming apparatus receives the printing file from the server and prints an image based on the printing file received.

### BRIEF DESCRIPTION OF THE DRAWINGS

FIG. 1A is a diagram showing an example of the rough structure of an image forming system according to an embodiment.

FIG. 1B is a diagram showing an example of the rough structure of an image forming apparatus according to an embodiment.

FIG. 2 is a flowchart illustrating an example of a print job registration processing according to an embodiment.

FIG. 3 is a flowchart illustrating an example of a specified printing processing on a print job according to an embodiment.

FIG. 4 is a flowchart illustrating an example of an emergent printing processing on a print job according to an embodiment.

FIG. 5 is a diagram showing an example of a authentication screen according to an embodiment;

FIG. 6 is a diagram showing a first example of the list display of print jobs;

FIG. 7 is a diagram showing a second example of the list display of print jobs;

FIG. 8 is a diagram showing a third example of the list display of print jobs.

### DETAILED DESCRIPTION

In accordance with an embodiment, an image forming apparatus comprises a display unit and an image forming unit. The display unit displays a list of print jobs. The image forming unit forms an image based on the print job registered last, if a first printing instruction is given without selecting a print job from the list of print jobs displayed on the display unit.

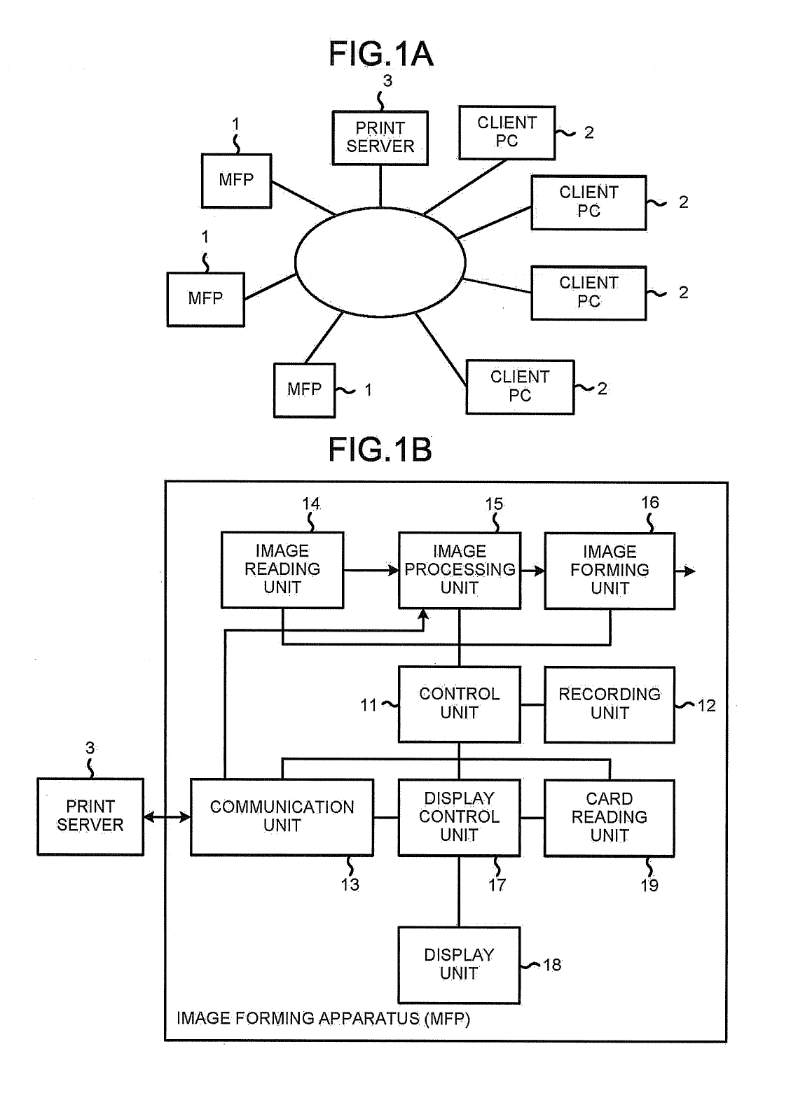

FIG. 1A is a diagram showing an example of the rough structure of an image forming system. As shown in FIG. 1A, an image forming system comprises, through the same network, a plurality of image forming apparatuses 1 (MFP (Multi-Functional Peripheral)), a plurality of client PCs 2 and a print server 3.

The print server 3 registers the print jobs sent from the client PCs 2 and retains the print jobs for a given time. Moreover, the print server 3 sends a requested print job corresponding to the print job request from any one of the plurality of image forming apparatuses 1. The image forming apparatus 1 requesting the print job receives the print job sent from the print server 3 and executes the print job. That is, the image forming apparatus 1 requesting the print job forms an image based on the print job sent from the print server 3.

FIG. 1B is a diagram showing an example of the rough structure of an image forming apparatus. As shown in FIG. 1B, the image forming apparatus 1 comprises a control unit 11, a recording unit 12, a communication unit 13, an image reading unit 14, an image processing unit 15, an image forming unit 16, a display control unit 17, a display unit 18 and a card reading unit 19. The control unit 11 carries out a control related to the forming (printing) of an image. The recording unit 12 records a print job. The communication unit 13 communicates with the print server 3 to send various kinds of information to the print server 3 and to receive various kinds of information from the print server 3. The image reading unit 14 is, for example, a scanner for reading the image data corresponding to an original image. The image processing unit 15 implements various image processing on the image data read or the image data (printing data) received from the print server 3. For example, the image processing unit 15 develops the image data received from the print server 3. The image forming unit 16 forms an image based on the image data processed by the image processing unit 15. The display control unit 17 controls the list display of print jobs that will be described later. The display unit 18 displays the list of print jobs. The card reading unit 19 reads the information of the authentication card that will be described later.

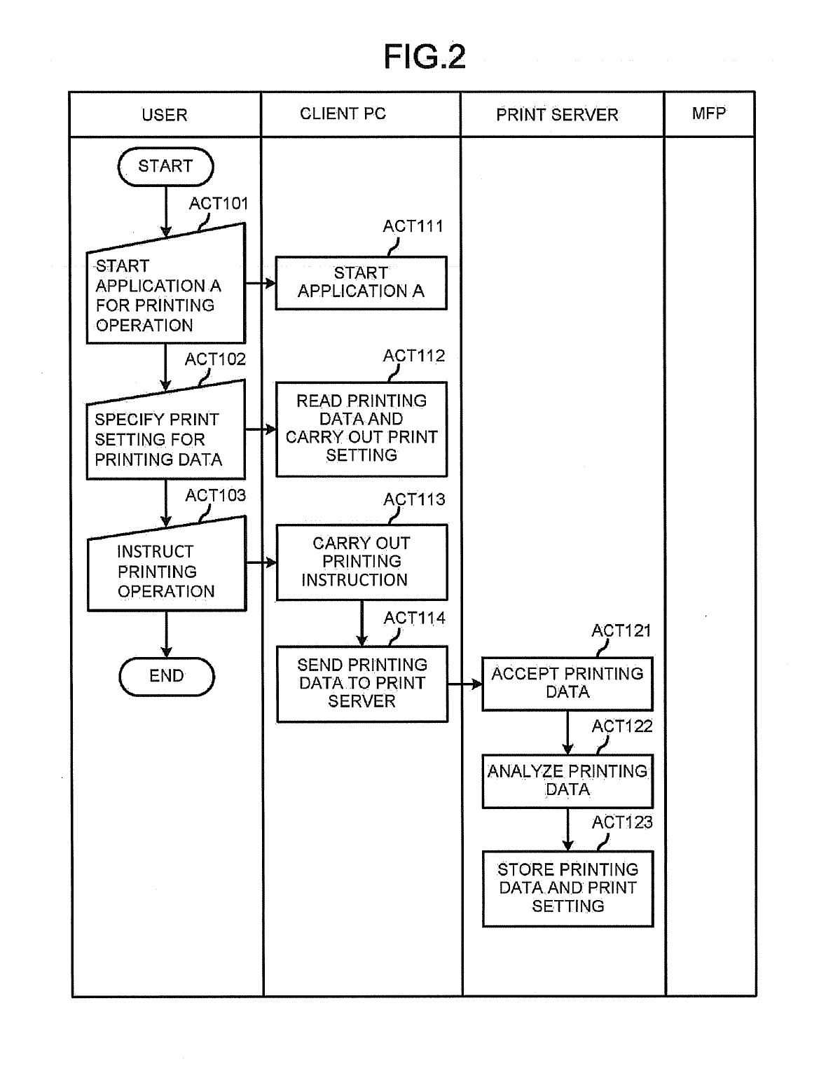

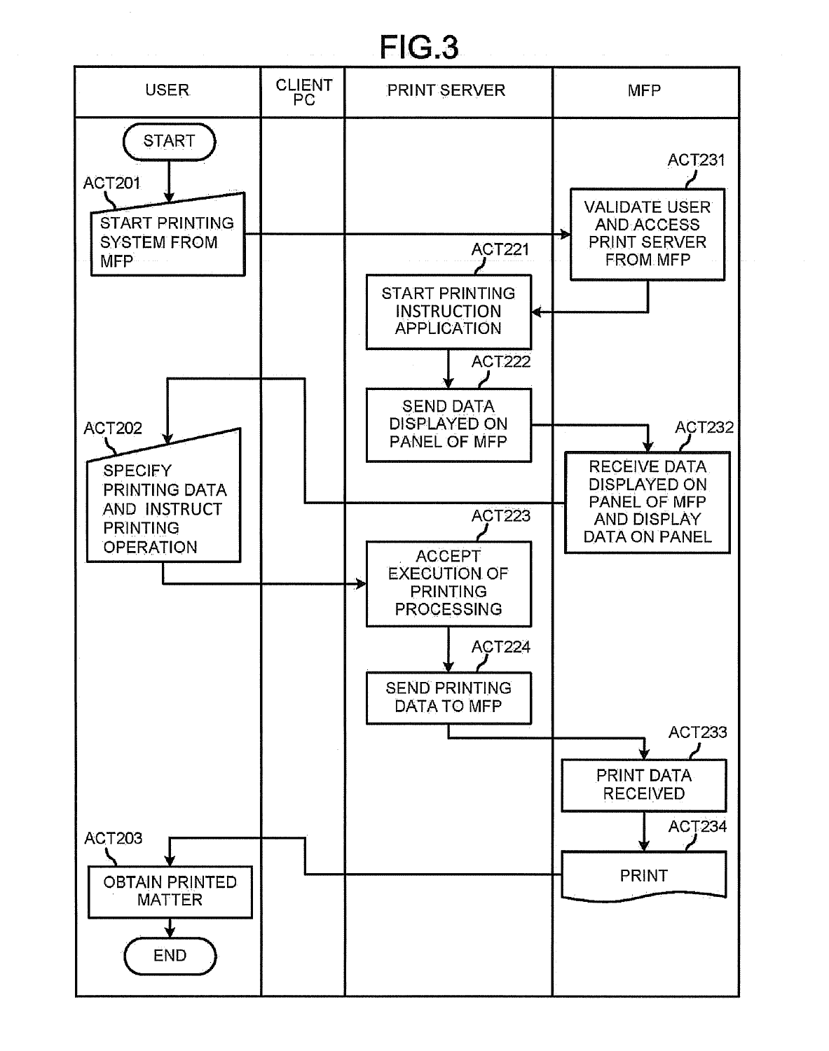

Next, two processing carried out by the image forming system are described with reference to the flowcharts shown in FIG. 2 and FIG. 3. The first processing refers to a registration processing in which a client PC 2 registers print jobs for the print server 3. A second processing refers to a specified printing processing in which the image forming apparatus 1 specifies a print job and further instructs a print of a print job after the printing specification.

FIG. 2 is a flowchart illustrating an example of a print job registration processing.

The user starts an application A for printing print object data at a client PC 2 (ACT 101). That is, the client PC2 starts the application A corresponding to the startup operation of the user on the application A (ACT 111). Next, the user specifies print object data and carries out a print setting (ACT 102) That is, the client PC 2 makes the application read the print object data corresponding to various operations of the user and carries out a print setting (ACT 112). For example, the print setting includes a user name (user identification information).

If a printing operation is instructed by the user (ACT 103), the client PC 2 starts the printing action of the application A corresponding to the printing instruction of the user (ACT 113) to send the print object data and the print setting to the print server 3 (ACT 114).

The print server 3 receives the print object data and the print setting (ACT 121), analyzes the print object data (ACT 122), associates the print object data with the print setting and registers the associated print object data and print setting as a print job (ACT 123). For example, the print server 3 registers a plurality of print jobs. In addition to the print object data and the print setting, a print job further contains print acceptance date/time information. For example, the print acceptance date/time information is the date/time when the print server 3 receives the print object data and the print setting.

FIG. 3 is a flowchart illustrating an example of a specified printing processing on a print job.

After the print object data is registered, the user starts a printing system from the image forming apparatus (ACT 201), and correspondingly, the image forming apparatus 1 carries out a authentication processing to identify the user and accesses the print server (ACT 231).

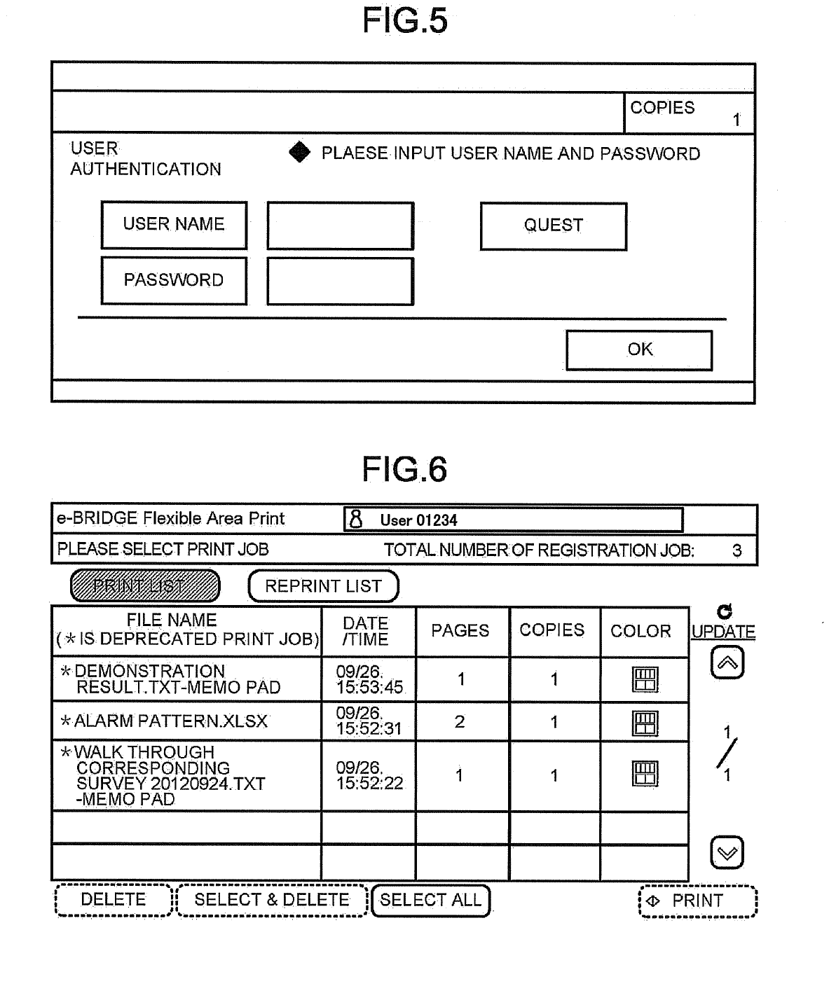

For example, the image forming apparatus 1 displays the authentication screen shown in FIG. 5 to request the input of a user name and a password. The user input a user name and a password through the authentication screen. The image forming apparatus 1 compares the input user name and password with those registered in advance and confirms, if the former is the same as the latter, the input user name and password are valid. Alternatively, the image forming apparatus 1 sends the input user name and password to the print server 3. The print server 3 compares the user name and password sent from the image forming apparatus 1 with those registered in advance and confirms, if the former is the same as the latter, the input user name and password are valid. Besides, the print server 3 starts a printing instruction application (ACT 221), retrieves the print job containing the user name recognized through the authentication, and sends display data for displaying the information related to the retrieved print job (e.g. the file name of a print object data printed through the print job) to the image forming apparatus 1 (ACT 222).

As stated above, a user name and a password may be input through a authentication screen on a touch panel or through an information recording medium (authentication card) in which a user name and a password are recorded. For example, the card reading unit 19 of the image forming apparatus 1 reads a user name and a password from a authentication card in a contact or non-contact manner.

The image forming apparatus 1 receives the display data sent from the print server 3, starts a display application accepting the printing instruction, and displays print jobs in a list manner on the panel thereof based on the display data (ACT 232). That is, the image forming apparatus 1 displays, on the panel thereof, the print jobs of the user name recognized through the authentication in a list manner.

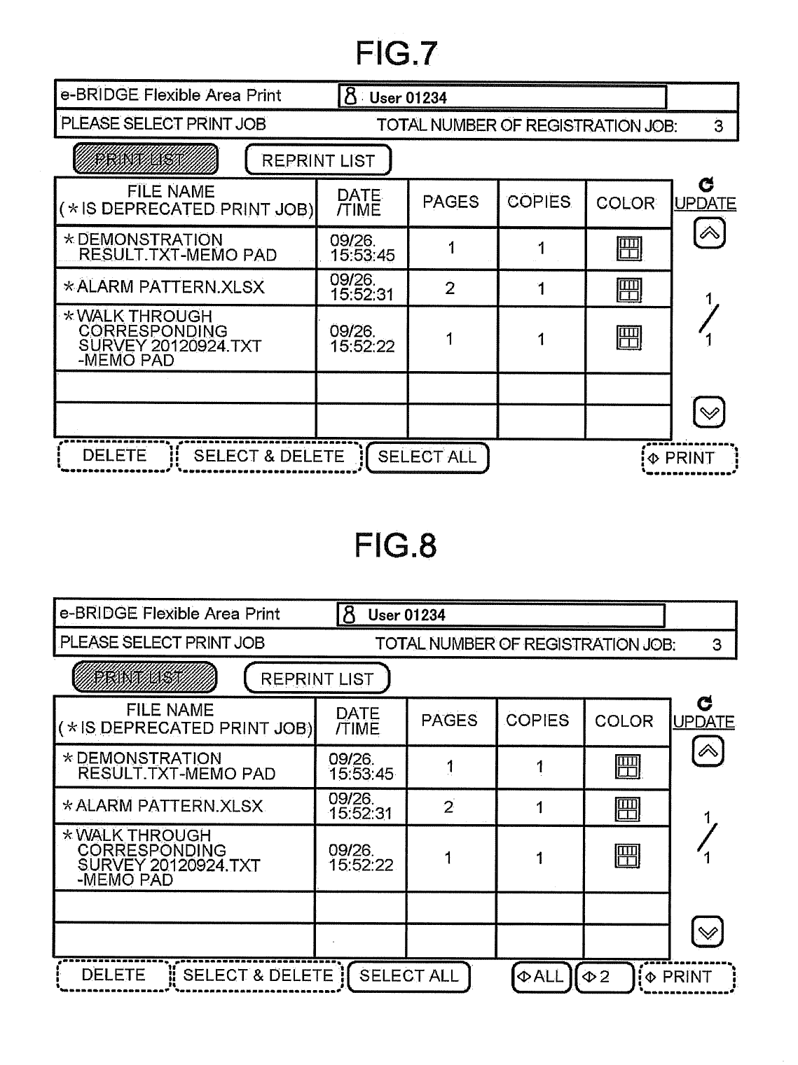

FIG. 6, FIG. 7 and FIG. 8 are diagrams each showing an example of the list display of print jobs. As shown in FIG. 6, FIG. 7 and FIG. 8, a print job is represented by a file name (information related to the print job), date/time information, page information, copies information and color information. FIG. 6 shows an example of a list display screen, in which a print icon shown is activated corresponding to the selection on a print job to accept a printing instruction through the print icon. FIG. 7 and FIG. 8 also show two examples of a list display screen, in each of which a print icon is always activated, and a choice may be made between a job selection printing processing of selecting a print job and accepting a printing instruction through the print icon, and an emergent printing processing of directly accepting a printing instruction through the print icon without selecting a print job.

The user selects a print job from the list (e.g. the displayed list shown in FIG. 7 or FIG. 8) of the print jobs displayed on the panel of the image forming apparatus 1, if the user instructs a printing operation through the print icon (ACT 202), then the image forming apparatus 1 accepts the printing instruction of the selected print job and instructs the print server 3 to execute the print job. The print server 3 accepts the execution of the print job (ACT 223) and sends the printing data corresponding to the print job, the execution of which is accepted to the image forming apparatus 1 (ACT 224). The image forming apparatus 1 receives the printing data, prints the printing data (ACT 233) and provides a print (ACT 234).

Through the actions above, the user can obtain a printed matter (ACT 203).

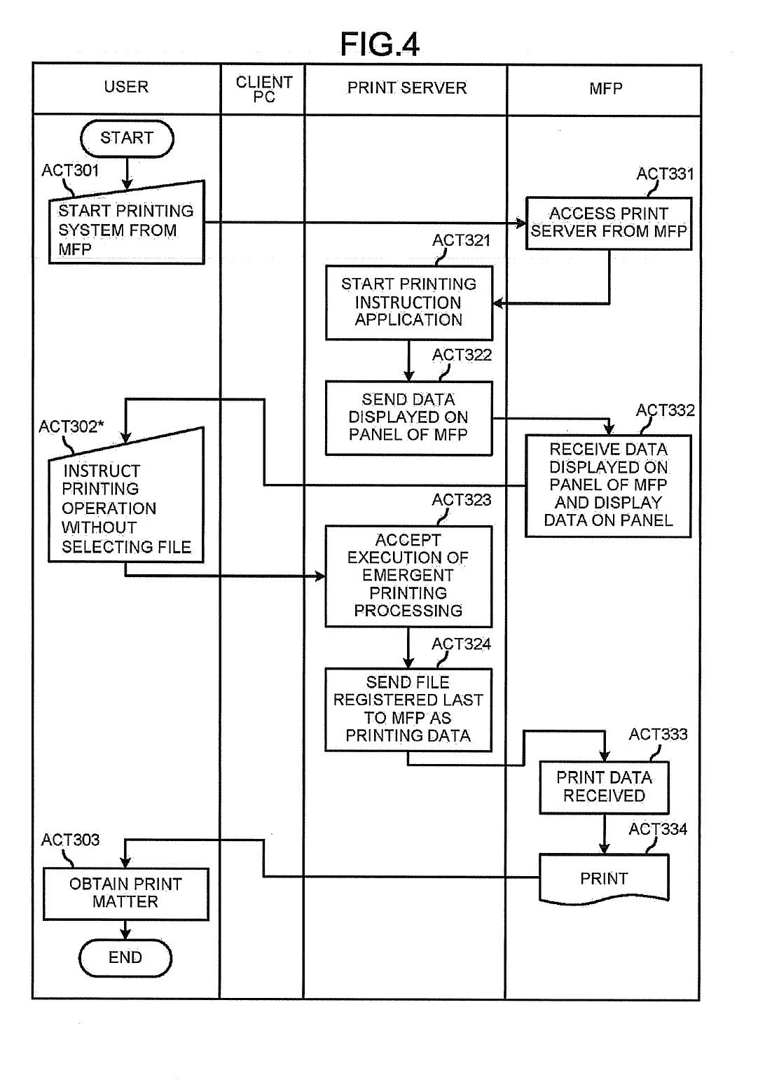

An example of the emergent printing processing is described. FIG. 4 is a flowchart illustrating an example of the emergent printing processing on a print job.

After the print object data is registered, the user starts a printing system from the image forming apparatus (ACT 301), and correspondingly, the image forming apparatus 1 carries out a authentication processing to identify the user and accesses the print server 3 (ACT 331).

For example, the image forming apparatus 1 displays the authentication screen shown in FIG. 5 to request the input of a user name and a password. The user input the user name and the password through the authentication screen. The image forming apparatus 1 compares the input user name and password with those registered in advance and confirms, if the former is the same as the latter, the input user name and password are valid. Alternatively, the image forming apparatus 1 sends the input user name and password to the print server 3. The print server 3 compares the user name and password sent from the image forming apparatus 1 with those registered in advance and confirms, if the former is the same as the latter, the input user name and password are valid. Besides, the print server 3 starts a printing instruction application (ACT 321), retrieves the print job containing the user name recognized through the authentication, and sends display data for displaying the information related to the retrieved print job (e.g. the file name of the print object data printed through the print job) to the image forming apparatus 1 (ACT 322).

As stated above, a user name and a password may be input through a authentication screen on a touch panel or through an information recording medium (authentication card) in which a user name and a password are recorded. For example, the card reading unit 19 of the image forming apparatus 1 reads a user name and a password from a authentication card in a contact or non-contact manner.

The image forming apparatus 1 receives the display data sent from the print server 3, starts a display application accepting the printing instruction, and displays print jobs on the panel thereof based on the display data (ACT 332). Here, the following shows an example of displaying the list display screens shown in FIG. 7 and FIG. 8.

If the user instructs a printing operation, instead of selecting a print job, from the list of print jobs (print jobs 1-N, N≧1, N: Integer) displayed on the panel of the image forming apparatus 1 (ACT 302*), the image forming apparatus 1 accepts the printing instruction of the print job N that is registered last in the list of print jobs (the latest print job) and instructs the print server 3 to execute the print job N. The print server 3 accepts the execution of the print job N (ACT 323) and sends the printing data corresponding to the print job, the execution of which is accepted to the image forming apparatus 1 (ACT 324). The image forming apparatus 1 receives the printing data, prints the printing data (ACT 333), and provides a print (ACT 334).

Through the actions above, the user can obtain the print of the print job N registered last by indicating a printing operation without selecting a print job (ACT 303).

If the image forming apparatus 1 prints the printing data corresponding to the print job N that is registered last, then the print job N that is registered last is deleted from the list of print jobs (print jobs 1-N). That is, the image forming apparatus 1 displays the list of the print jobs excluding the print job N that is registered last (print jobs 1-(N−1)). In this state, if the user instructs a printing operation, instead of selecting a print job, again from the list of print jobs displayed on the panel of the image forming apparatus 1, the image forming apparatus 1 accepts the printing instruction of the print job (N−1) that is registered last in the list of print jobs and instructs the print server 3 to execute the print job (N−1). That is, the execution of the print job (N−1) registered prior to the print job N registered last is instructed. The print server 3 accepts the execution of the print job (N−1) and sends the printing data corresponding to the print job (N−1) the execution of which is accepted to the image forming apparatus 1. The image forming apparatus 1 receives and prints the printing data and provides a print.

Through the actions above, the user can obtain a printed matter by indicating a printing operation repeatedly, instead of selecting print jobs, in accordance with the following order: the print job N that is registered last, the print job (N−1) registered prior to the print job registered last, and the print job (N−2) registered prior to the print job (N−1).

An icon for printing two jobs and an icon for printing all jobs are contained in the list shown in FIG. 8. If the user selects the icon for printing two jobs, then the image forming apparatus 1 accepts, from the print server 3, the print job that is registered last and the print job that is registered prior to the print job registered last, and prints the two print jobs. Moreover, if the user selects the icon for printing all jobs, then the image forming apparatus 1 accepts, from the print server 3, all the print jobs displayed in the list, and prints all the print jobs.

An icon (e.g. represented in red color) for printing the jobs generated in the past a (e.g. 1 h) time, an icon (e.g. represented in blue color) for printing the jobs generated in the past b (e.g. 2 h) time and an icon (e.g. represented in green color) for printing the jobs generated in the past c (e.g. 1 day) time can also be configured in the list. If the user selects the icon for printing the jobs generated in the past a time, then the image forming apparatus 1 accepts the print jobs generated in the past a time from the print server 3 and prints the print jobs. Further, if the user selects the icon for printing the jobs generated in the past b time, then the image forming apparatus 1 accepts the print jobs generated in the past b time from the print server 3 and prints the print jobs. Further, if the user selects the icon for printing the jobs generated in the past c time, then the image forming apparatus 1 accepts the print jobs generated in the past c time from the print server 3 and prints the print jobs.

Through the actions above, the user can obtain a desired print merely by indicating a printing operation without selecting a file from the list. That is, the image forming apparatus provided in this embodiment is more convenient as being capable of obtaining a desired print with one action decreased when compared with an occasion which instructs a printing operation after a file is selected from a list.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a display unit configured to display a list of print jobs; and
an image forming unit configured to form an image based on the print job registered last, if a first printing instruction is given without selecting a print job from the list of print jobs displayed on the display unit.

2. The image forming apparatus according to claim 1, further comprising:
an acceptance unit configured to accept an information for identifying a user, wherein
the display unit displays the list of print jobs associated with the user identified.

3. The image forming apparatus according to claim 1, further comprising:
a communication unit configured to receive the print jobs associated with the user identified from a print server.

4. The image forming apparatus according to claim 1, wherein
the image forming unit forms an image based on a first print job registered last in the list of print jobs displayed on the display unit according to the first printing instruction for the first time and an image based on a print job previous registered of the first print job in the list of print jobs displayed on the display unit according to a second printing instruction.

5. The image forming apparatus according to claim 1, wherein
the display unit displays the list that is deleted the first print job from the list of print jobs corresponding to the forming of the image based on the first print job.

6. The image forming apparatus according to claim 1, wherein
the image forming unit forms an images based on a plurality of predetermined print jobs included in the list of print jobs according to a third printing instruction.

7. An image forming apparatus, comprising:
a display unit configured to display a list of print jobs; and
an image forming unit forms an image based on at least one print job in the list of print jobs that is registered in the time from the current moment back to a first past moment, if a first printing instruction is given without selecting the print job from the list of print jobs.

8. The image forming apparatus according to claim 7, wherein
the image forming unit forms an image based on at least one print job in the list of print jobs that is registered in the time from the current moment back to a second past moment according to a second printing instruction.

9. The image forming apparatus according to claim 8, wherein
the instruction icons are displayed on the display unit by a plurality of colors.

10. An image forming method, comprising:
displaying a list of print jobs; and
forming an image based on a print job registered last, if a first printing instruction is given without selecting a print job from the list of print jobs displayed on the display unit.
